(19) United States
(12) Patent Application Publication
(10) Pub. No.: US 2013/0203022 A1
(43) Pub. Date: Aug. 8, 2013

(54) REFRESHABLE BRAILLE DISPLAY

(71) Applicant: Mahmoud Al-Qudsi, Wheaton, IL (US)

(72) Inventor: Mahmoud Al-Qudsi, Wheaton, IL (US)

(21) Appl. No.: 13/365,367

(22) Filed: Feb. 3, 2012

(51) Int. Cl. G09B 21/00

(52) U.S. Cl. 434/113

(57) ABSTRACT

A refreshable Braille display created by movable actuators having discrete surfaces bearing protrusions. In a particularly preferred embodiment, a pair of actuators has discrete surfaces bearing portions of Braille characters, so that when the pair is read together, the entire Braille characters may be read. Movement of the actuators, which may be rotating discs, may be controlled by electromechanical and/or electronic devices.

### BACKGROUND OF THE INVENTION

The present invention relates generally to devices used to display text in Braille for reading by the visually impaired, and more particularly to electromechanical Braille displays of a refreshable nature used as output devices for personal or embedded computer systems.

In the information age and in an era of unprecedented connectivity by means of digitized text and documents, visually impaired, and especially legally blind, individuals are often left behind due to the lack of affordable and effective technology bridging the gap caused by the heavy reliance on visual and optical display units. While the U.S. government has passed several laws and acts, beginning with the Americans with Disabilities Act, mandating equal opportunities to access these resources in an attempt to further the rights of the visually, audibly, and otherwise impaired persons, unfortunately technology has not yet reached a point where it can be said to have met the demands and expectations set forth to provide visually impaired persons with comparable access to the wide array of communication options and outlets that their non-visually-impaired peers are able to take for granted, despite attempts in the past at providing effective alternative means to presenting digitized text and data to the visually impaired.

Devices and techniques for providing refreshable Braille displays are known. Most of such devices and techniques use the manipulation of individual pins actuated by motors, solenoids, or other electromechanical implements that power and provide the up and down motion used to represent the individual Braille dots, instances of which can be seen in U.S. Pat. Nos. 2,891,324; 4,871,992; 4,266,936; 6,700,553; 5,766,014; and 5,453,012, each of which are incorporated by reference in their entirety here.

A more recent method of forming the Braille characters by means of piezoelectric materials that expand and contract under certain stimuli to create the Braille cells, such as those described in U.S. Pat. No. 7,775,797, which may be grouped and assembled systematically to create displays similar to those in U.S. Pat. No. 6,743,021, contain less moving parts and can operate with a higher precision, but at the cost of highly-increased prices and, in some cases, the need to create large electromagnetic fields to trigger changes in the state of the piezoelectric materials.

Other techniques at experimenting with different approaches than those of the standard emulation of embossed Braille text, such as U.S. Pat. No. 6,776,619, using Braille characters embossed onto a wheel that turns to simulate the letters in sequence, are also known, but these and other similar attempts have been unable to reach the same levels of natural readability and convenience that the simulation of traditional Braille text provides.

The different, typical approaches currently being developed suffer from shared drawbacks involving high cost and a high per-letter/per-object complexity, largely as a result of their attempts at “creating” a Braille letter via the manipulation of individual dots or protrusions. As a result, there does not exist a refreshable Braille display on the market that can be mass-produced and sold at affordable prices to the blind both here in the United States as well as internationally in less prosperous corners of the world, with both the convenience and scale that this invention provides.

These existing technologies also suffer from scalability issues in that these methods may only be used to generate one or two lines of text at the most due to limitations of both size and cost; the existing products are not feasible for a display of more than two lines of eighty characters, while most of the technologies cannot feasibly meet even that limit. Ideally, more rows of Braille text are preferable; however, with the complexity of the actuators and/or electromagnetic fields and the close spacing of the Braille dots within a cell, the number of Braille characters that may be displayed on devices employing these known techniques is limited.

Even within the technological limits of their scalability, the price of these high-complexity approaches at making refreshable Braille displays makes them costly choices for displays of considerable size, such that a display of only eighty characters is considered to be of an extremely generous size. A device that can display a full page of text, which is the ideal goal that most-closely resembles printed Braille documents, would have to rely on mechanics and techniques both cheap and simple, and would greatly improve productivity and reading efficiency as well as reach the hands of more visually impaired persons worldwide.

Other techniques such as voice synthesizers and text-to-speech software are inadequate solutions that do not address the original problem and instead attempt to work around it by converting material originally intended to be consumed via sight to audible content; such techniques do not offer any means of skimming through documents or reading at one's pace, and are ill-adapted for the vocabulary and presentation of most technical material such as those found in engineering, medical, scientific, and mathematical fields, to name a few. This is particularly true when it is recognized that while audio-based solutions can be used by both the visually-impaired and those blessed with the gift of sight equally, screen reading software is used exclusively by the former as it is an awkward and unpleasant method of interacting with the computer.

Accordingly, there is a tangible need for a refreshable Braille display that overcomes the above limitations in order to provide the visually impaired with a more effective means of consuming information in the digital world, including providing technology that can be implemented and mass-produced at an affordable price.

### SUMMARY OF THE INVENTION

The objects mentioned above, as well as the objects mentioned immediately below and still other objects that will be apparent from reading the foregoing, are solved by the present invention, which overcomes disadvantages of prior refreshable Braille displays and methods of using them, while providing new advantages not believed associated with such known displays and methods.

The present invention enables the production and use of a better refreshable Braille display with lower complexity and higher scalability, while using more affordable materials and components.

One object of this invention is to provide a refreshable Braille display that has the ability to display text, technical materials, books, and other written matter in a standard Braille format akin to that of a normal, printed Braille document for visually-impaired persons.

Another object of this invention is to provide a means of forming Braille characters half-a-character at a time without resorting to the manipulation of the individual Braille dots.

Still another object of this invention is to provide the basis for a scalable refreshable Braille display that can be built at full-page sizes, especially at a non-prohibitive cost and complexity.

Still another object of this invention is to provide a method of forming complex Braille characters of over sixty-four possible combinations per letter via simple rotation of electromechanical parts without resorting to the complicated methods of actuator/solenoid arrays and piezoelectric materials.

Still another object of this invention is to provide a way to create lines of Braille text without requiring multiple actuators per Braille cell, or even a single actuator per Braille cell.

Still another object of the present invention is to provide a Braille display system which can present text normally shown on a computer terminal display to a visually impaired person.

Still another object of this invention is to provide a Braille display system that has a continuous and uninterrupted tactile reading surface for the user, eliminating any interference with the reading of Braille characters.

Accordingly, in one preferred embodiment of the present invention, a refreshable Braille display is provided that includes a plurality of regular polygonal wheel-like components referred to as Braille discs, with two such discs used to form each individual Braille character and with the different distinct combinations of Braille half-letters embossed onto each of the regular sides/faces of each disc, such that they may be arranged and permuted to form all possible Braille characters, and such that the combination of Braille discs are operable as the display of a personal computer, embedded device, or other electronic or electromechanical device, to allow a blind person to discern the information displayed thereon by reading the Braille characters.

In a preferred embodiment, at least one electromechanical device may be employed to operably connect to the Braille discs to power the permutation of Braille characters by rotating the discs to select the appropriate faces needed for each half-character position. Each Braille character in the text may be formed by “reading” (feeling) the faces of two of the Braille discs in sequence, with each character including either six or eight Braille dots. This procedure may be repeated multiple times as necessary to fully generate the entirety of the length of the text intended to be displayed.

Using these methods, it becomes possible to generate an entire line of text with only one or two actuators per-line, thereby greatly reducing the cost, weight, complexity, and size of the device compared to previous solutions focusing on the manipulation of individual dots, without sacrificing the similarities to conventional Braille text as other experimental solutions have required. The use of more actuators per line of Braille text remains an option, and may be used to speed up the generation of the Braille text, with the caveat of increasing cost and complexity, albeit not to the same extent as methods requiring an actuator per Braille dot or Braille cell.

In a particularly preferred embodiment, a refreshable Braille display is provided. The device for providing this display may include a plurality of movable actuators. Each actuator may have protrusions on its outside surfaces that form possible portions of a Braille character. The surfaces of adjacent actuators may be moved and permutated to generate entire characters of readable Braille text. The actuators may be rotatable discs, for example, and each of the discs may have a plurality of faces bearing the protrusions. In a further example, the discs may be wheels in the shape of regular polygons.

In a preferred example disclosed here, the protrusions on a particular face may form possible portions of (e.g.) one-half of a Braille character, such that the faces of adjacent discs read together form entire Braille characters. The discs may be rotated and permutated to allow the reading of multiple lines of Braille text.

In another embodiment, a device for providing a refreshable Braille display is disclosed and claimed, and includes a housing having a reading plane, and a plurality of Braille discs rotatable on an axis and mountable within the housing. In this example, each disc may have a plurality of faces, and each face may have protruding dots that form portions of Braille characters which display on the reading plane. When adjacent faces of adjacent discs are read on the reading plane, entire Braille characters may be read, enabling a blind person to read the adjacent faces of rotated and permutated Braille discs as Braille text. In a particular embodiment, information from a personal computer monitor may be transmitted to an electromechanical device controlling movement of the Braille discs. One or more electromechanical devices may be operably attached to the axis and used to rotate the axis and the Braille discs into desired positions. In another embodiment, a microcontroller may be used to control the operation of the one or more electromechanical devices. One or more electronic devices may be used to control the microcontroller, so that information and data from the electronic device may be transferred from the microcontroller to the one or more electromechanical devices, enabling a visually impaired person to read information on the reading plane that has been supplied from the electronic device. The electronic device may include one or more of the following: a personal computer; a mainframe computer; a PDA (personal display assistant, such as cell phone, Blackberry, etc.); an embedded microcontroller; or a wirelessly attached controller.

A method of displaying Braille characters on a reading plane using adjacent actuators is also provided. Each of the actuators may have multiple discrete surfaces bearing protrusions that collectively enumerate all possible combinations for half of a Braille letter, so that adjacent actuators allow the reading of valid Braille characters. A first actuator may be rotated into a position such that a discrete surface of the first actuator is visible on the reading plane. A second actuator may be rotated to a position adjacent the first actuator into a position such that a discrete surface of the second actuator is substantially coplanar with the discrete surface of the first actuator, thereby forming a single Braille character from the combination of the (e.g.) two half-letters formed by the movement of the actuators. These steps, with these and other actuators, may be continued to enable a visually impaired person to read multiple lines of Braille on the reading plane. Each actuator may include a rotatable disc. An electronic device may be used to transmit control signals to control movements of the actuators to provide Braille characters in an order which may be read, as stored in the memory of the electronic device. One or more electromechanical devices may be used to move the actuators in response to control signals from the electronic device received by the one or more electromechanical devices. The electronic device may include one or more of the following: a personal computer; a mainframe computer; a PDA; an embedded microcontroller; or a wirelessly attached controller.

### Definition of Claim Terms

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Actuator” means a rotatable disc, sliding pane, or other item which has discrete surfaces or “faces” bearing protrusions (such as dots) with partial Braille characters.

“Protrusion” means a raised surface, which may take the form of a dot or cubic raised surface, for example, which together forms Braille characters which may be read by visually impaired persons.

“Read” means the act of a visually impaired person obtaining sensory data from the Braille characters and mentally interpreting that data, thereby “reading” the Braille symbols.

### BRIEF DESCRIPTION OF THE DRAWINGS

The novel features which are characteristic of the invention are set forth in the appended claims. The invention itself, however, together with further objects and attendant advantages thereof, will be best understood by those familiar with the art by reference to the following description taken in connection with the accompanying drawings, in which:

FIG. 1 is a schematic top view of a standard six-dot Braille character;

FIG. 2 is a schematic top view of a standard eight-dot Braille character;

FIG. 3 is a side view of a single Braille disc in an embodiment of this invention, showing faces 3A to 3H and detailing unique combinations of Braille dots embossed on the sides of the regular polygon disc;

FIG. 4 is a perspective front and side view of the Braille disc in FIG. 3, illustrating an embodiment in which the internal polygon is cut away, as possible method of achieving the rotation of the Braille disc;

FIG. 5 is a top view of the present invention in one of its embodiments, showing the surface upon which the text is to be generated, along which the visually impaired reader slides his or her finger horizontally in a manner distinctly familiar to users of the Braille language;

FIG. 6 is a top view of a preferred embodiment of a housing having a reading plane useful with the present invention;

FIG. 7 is a top and side perspective view, with the housing cut-away, to show the insides of an embodiment of this invention, detailing the manner in which the Braille discs of FIG. 4, four of which are shown for illustrative purposes, may be aligned with one another and an illustrative manner in which the chosen face may be rotated to become visible on the reading plane;

FIG. 8 is a schematic diagram illustrating possible methods of controlling the refreshable Braille display device which determines the text to be displayed in Braille, and means by which it may be attached and interfaced with an external personal computer or other electronic device;

FIG. 9 is a perspective view showing a simplified illustration of motor 7C and attached head 7D shown in FIG. 7, and illustrating one possible configuration of an electromechanical device powering the rotation and selection of Braille characters in a sample embodiment of this invention;

FIG. 10 is a perspective view of of a polygonal prism with a hollowed-out shaft in the center that may be used in conjunction with the motor and shaft of FIG. 9 to allow for the selection and rotation of a single Braille disc out of many in a line of text with only one motor, as shown in FIG. 11;

FIG. 11 is a top and side perspective view of a simplified, possible embodiment of this invention with the intention of illustrating a mechanical process whereby any single Braille disc in a line of Braille discs may be individually selected and rotated to a chosen face by means of only two electromechanical devices, without incurring the rotation of all other Braille discs on the row/line.

The components in the drawings are not necessarily to scale, emphasis instead being placed upon clearly illustrating the principles of the present invention.

### Detailed Description of the Preferred Embodiments of the Invention

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

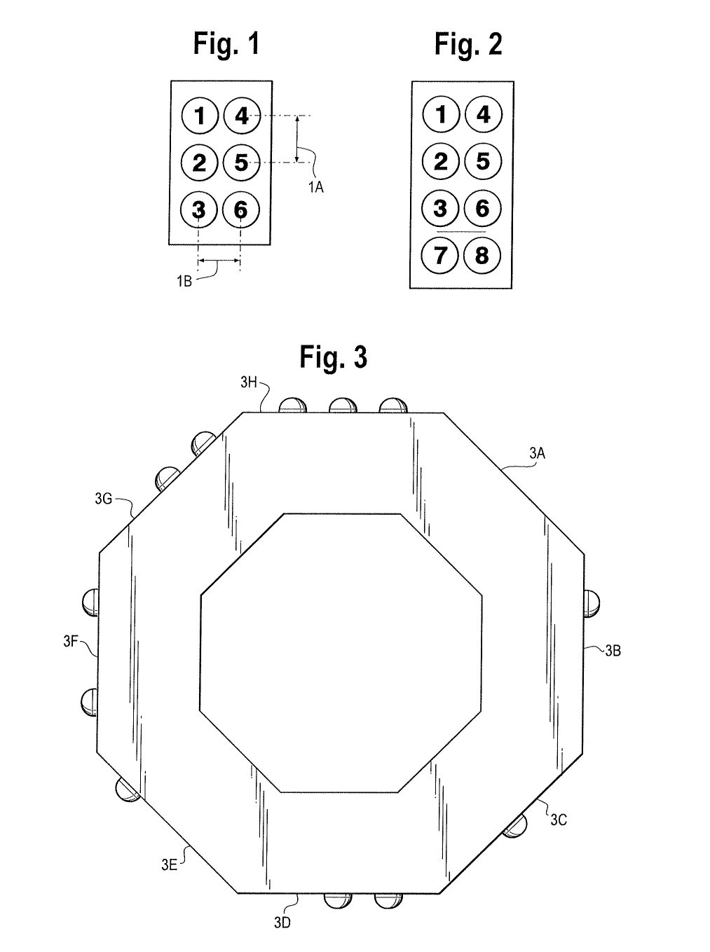

The present invention is based on the concept of forming Braille text using a series of actuators (such as but not limited to rotating discs, or sliding panes) with faces selectable from a pool containing all possible Braille characters, instead of dynamically generating/creating the Braille character to be displayed. When the actuators are configured with the chosen Braille character and placed into a desired location, the resulting array of actuators can be read from left-to-right, for example, so that readable text is displayed. However, given that Braille text includes two columns of either three or four rows of raised protrusions (depending on the Braille standard) to create six (FIG. 1) or eight (FIG. 2) dots per character, this would require that a Braille display be capable of cycling between sixty-four or two hundred and fifty-six possible permutations for each actuator.

The complexities of such a solution quickly meet and surpass those of existing methods that manipulate the individual Braille dots, and is believed to be the reason such a method has not been previously preferred. The method employed by the present invention is to form each portion of a Braille character (e.g., a vertical one-half character or a horizontal one-half (or one-quarter or one-third) character) independently. In doing so, the total number of unique permutations of the Braille dots on an actuator drops (in the vertical one-half character example) from sixty-four or two hundred and fifty-six to only eight or sixteen, respectively.

With the present invention, the eight or sixteen unique combinations of Braille dots in raised or unraised (that is to say, present or non-present) form may be embossed on an actuator, such as on the faces of a polygonal wheel, two of which can be rotated and permuted in sequence or in parallel to form a Braille character on the reading plane of the embodiment of this device.

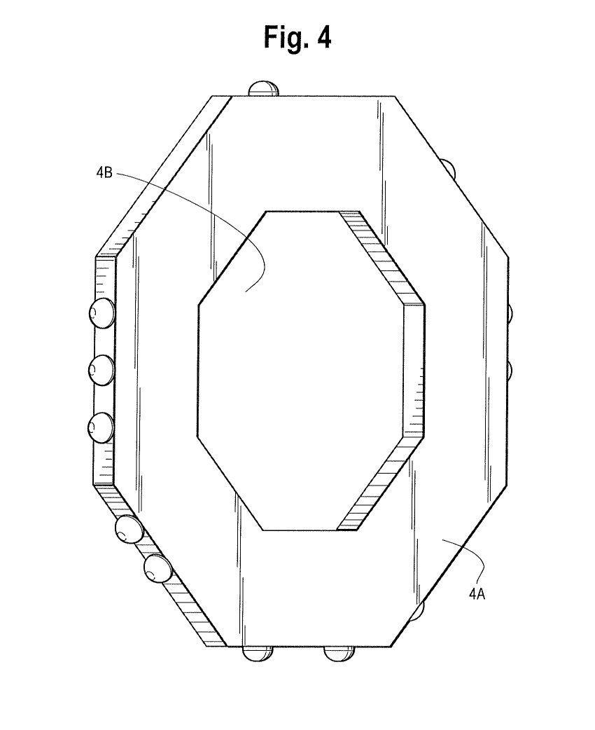

Referring now to the drawings and, more particularly, to FIG. 3, there is shown a view of an embodiment of the present invention in which the different combinations required to form the basis of (e.g.) one-half of a three-row Braille cell (FIG. 1) are shown embossed onto the eight faces of a regular octagonal disc, respectively matching the eight possible distinct combinations (going in order from face 3A to face 3H): ___, x__,_x_, x x _, __x, x_x, _x x, and x x x, where “x” represents the presence of a Braille dot and “_” denotes its absence. One advantage of such a design is that all the Braille discs in this embodiment of the invention are exactly identical, helping to both make the production of this device more cost-effective and less complex, while also lowering the maintenance costs associated with such Braille displays.

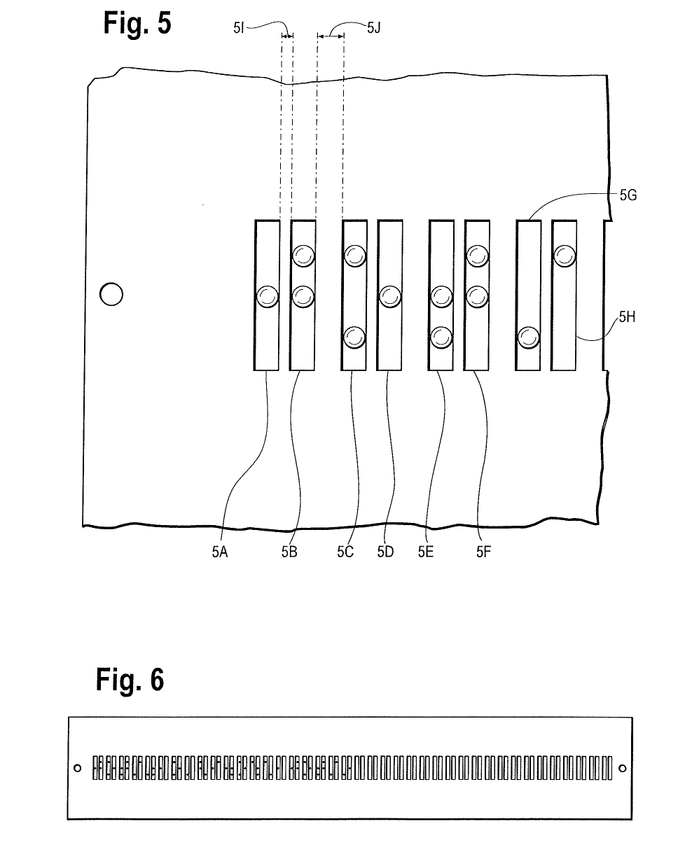

Referring now to FIG. 4, the protrusions on the Braille disc are intended to be of a shape, width, length, and height not dissimilar to those of traditional Braille dots on printed text. FIG. 5 shows one embodiment of the invention for the purpose of illustrating an exemplary grouping and arrangement of the Braille discs; in this embodiment, four characters are displayed in the eight slots opened in this portion of the top of the housing to form the reading plane.

Referring now to FIG. 7, a simplified view of an embodiment of the present invention is shown, providing an exemplary manner in which the faces of the Braille discs may fit into the openings cut away in the top cover of the housing, and the manner in which they may be concentrically aligned along axis 7B. Axis 7B and various parts of the machinery may be mounted on base 7E within housing 7F, as shown. In FIG. 7, for illustrative purposes only, four Braille discs 7A (the four of which together can be used to form two Braille characters) are shown.

Still referring to FIG. 7, in the preferred method of forming Braille characters disclosed here, each Braille disc 7A may be rotated about a central axis 7B a fixed number of degrees dependent on the number of faces that must be passed to reach the desired face. For example, in the embodiment of this invention using an octagonal Braille disc shown possessing eight faces in FIG. 4, each rotational increment of 45 degrees will cause movement to a new successive face, changing the next combination of Braille dots that are then visible through slots 5A through 5H in the top cover (FIG. 5) of the housing (FIG. 6), which serves as a reading plane.

As shown in FIGS. 5 and 7, it can be seen that the distance between adjacent pairs of Braille discs (5J) is noticeably greater than the distance between each disc within a pair (5I). The distance between each disc of a pair forms the distance between the two columns of a single Braille character, while the distance between adjacent pairs forms the distance between two separate characters of Braille text. These distances have been formalized in Specification 800 “Braille Books and Pamphlets,” from the National Library Service for the Blind and Physically Handicapped of the Library of Congress (incorporated herein by reference) as being: (a) 2.34 mm from center-to-center of adjacent Braille dots both horizontally 1A and vertically 1B within a Braille character; and (b) 6.2 mm from center-to-center of the dots in adjacent characters 5J. Each dot (as shown on 4A) is also preferably 0.48 mm in height, with a base diameter of 1.44 mm. The selected face of the Braille disc may be designed to be, upon the completion of rotation to the selected face, flush with the top cover of the housing in order to present as close a simulation of the touch and feel of traditional Braille text as possible, and in an uninterrupted fashion.

This invention does not place a constraint on the means by which movement of the actuators is accomplished. For example, instead of rotating discs, sliding panes may be electromechanically moved into adjacent location. Still other types of actuators may be envisioned, provided that adjacent pairs of actuators are used to form entire Braille characters.

In one embodiment of this invention, an electromechanical rotation actuator 7C with a head 7D shaped in the form of a regular polygon and made to fit into inner polygon of the Braille disc (FIG. 4) may be used to rotate the disc about axis 7B as needed. Movement actuator 7C may then be moved horizontally along axis 7B to the next Braille disc in need of being rotated in order to select the correct face with regard to the letters and text being currently formed.

One possible method of achieving this rotation of an individual Braille disc out of, and the lateral movement between, a row containing many such Braille discs is detailed in FIGS. 9 through 11. Shown in FIG. 9 is a motor 9A with a long, circular head 9C on which is mounted a polygonal protrusion 9B of a shape and size designed as the inverse of the polygonal cutout in the center of FIG. 4, such that it meshes within a Braille disc in this sample embodiment. The purpose of this motor is to rotate a selected disc and thereby select the appropriate partial Braille character face. FIG. 10 shows a long, polygonal prism (“octagonal jacket”) hollowed out in the center to fit around, and rotate freely about, the shaft of motor 9C.

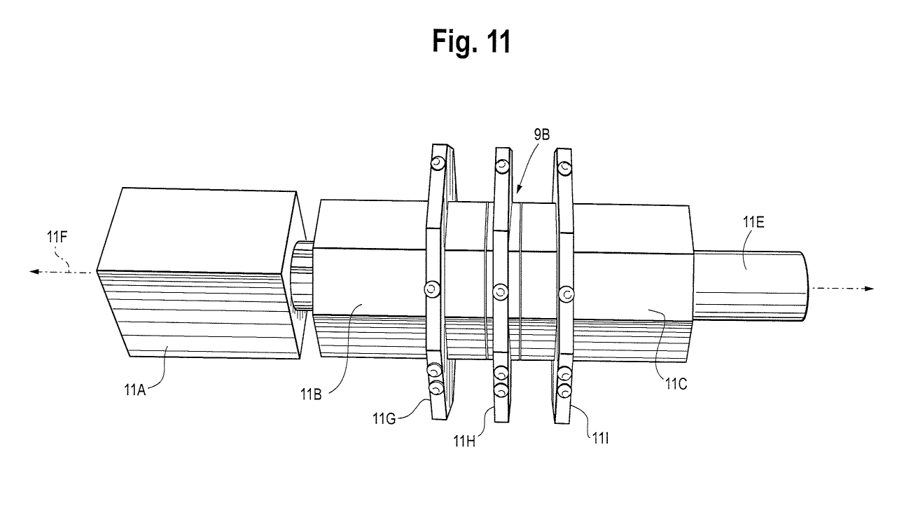

FIG. 11, a very basic embodiment of this invention intended only to illustrate a method through which this method of forming Braille text can be used to create an entire line with no more than two motors, shows the positioning of two such octagonal jackets, 11B and 11C, that may be slid into position with one on either side of protruding polygon 9B. Braille discs 11G, 11H, and 11I, which may be read to form a line of text, may be mounted about the polygonal surface formed by the adjacent positioning of both the octagonal jackets and the polygonal protrusion sandwiched in the middle. Accordingly, discs 11G and 11I are both prevented from unwanted rotation about axis 11F and yet free to slide laterally along axis 11F, were they not restricted in position.

Upon the activation of motor 11A, rotation of motor shaft 11E and welded/attached protrusion 11D will occur, while octagonal jackets 11B and 11C will not be rotated due to their loose coupling around shaft 11E. In this manner, Braille disc 11H, being aligned with rotating protrusion 11D, can be individually rotated without affecting the currently selected faces of Braille discs 11G and 11I, which remain in place. When the assembly of FIG. 11 is moved laterally along axis 11F by means of a second motor (not shown), assembly components 11A, 11B, 11C, 11D, and 11E will all be moved accordingly, while Braille discs 11G, 11H, and 11I (in this example) will remain held in place via the top cover of the housing (i.e. the reading plane) as shown in FIG. 7. (Optionally, other fastenings or guides may be used to hold these items in place.) Accordingly, rotating, polygonal protrusion 11D can be moved from one Braille disc to another, each time pausing long enough to allow for the rotation of the selected Braille disc via motor 11A. While this illustrates one possible method in which an entire line of Braille text can be formed with the usage of only (e.g.) two motors, saving drastically on both cost and complexity, those of ordinary skill in the art will understand that other ways to accomplish this may be employed.

In a different embodiment, gears may be used to mesh the actuator head with teeth mounted on the side or cut into the center of the Braille discs, and in another possible embodiment multiple actuators may be used in place of one actuator moving from one Braille disc to the other.

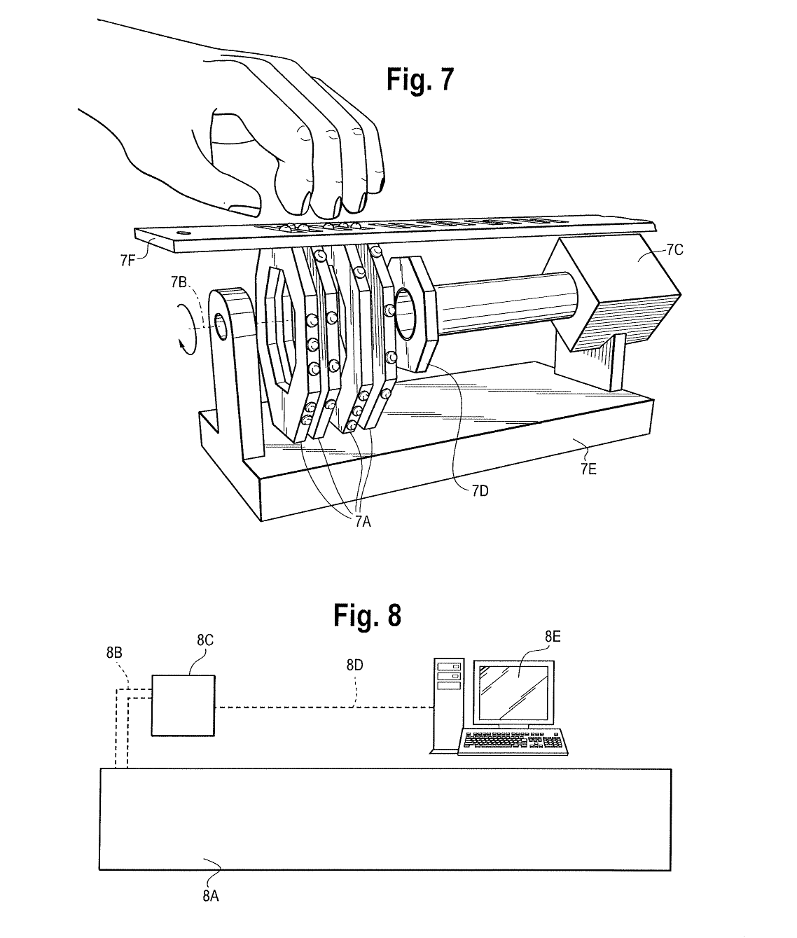

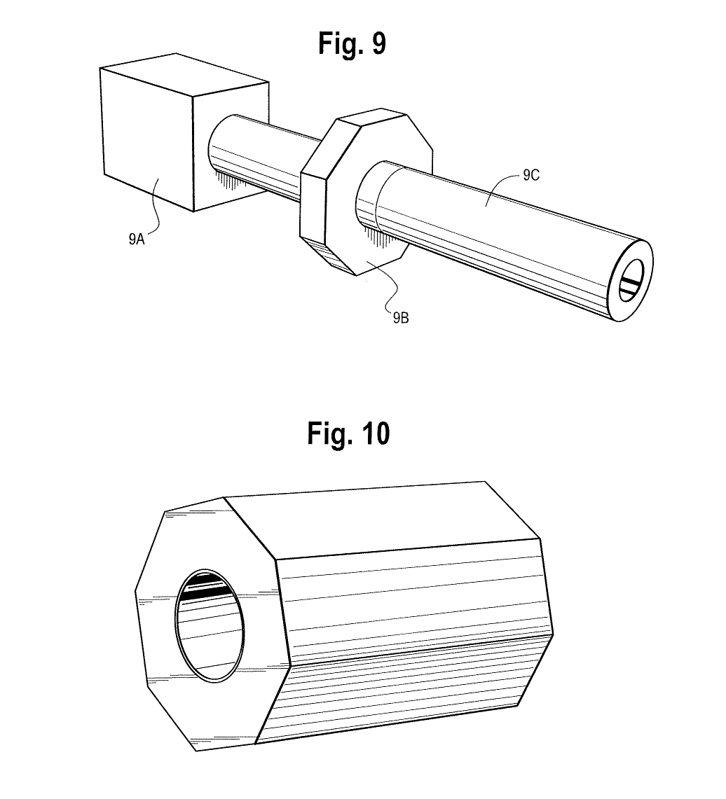

Referring now to FIG. 8, two possible means of controlling the output of the device are shown in a block diagram. 8A represents the refreshable Braille display device. 8C may be a microcontroller connected by leads 8B to the electromechanical actuator(s) powering the rotation of the Braille discs within device 7C. Device 7C is preferably contained within the housing of FIG. 6. 8D shows the data cable connecting microcontroller 8C to a personal computer or other electronic device 8E. The conversion from text to rotations of Braille discs required to display the text may be performed by means of readily available Braille translation software on the external device, in which case data cable 8D transfers data and information, translated and otherwise conditioned by the software, from the computer to microcontroller 8C, which controls the Braille output. Microcontroller 8C may contain firmware and memory capacity, including nonvolatile memory, which may be programmed to actuate the electromechanical device(s) for rotation and selection of the Braille faces.

In an alternative configuration, the computer or other external device 8E may only be used to convey the text required to be displayed over data cables 8D to microcontroller 8C, which would then engage in the conversion of the Braille text into the necessary movements of the electromechanical actuator(s) by means of the aforementioned firmware installed on the microcontroller.

It is also possible in yet another alternative configuration of this present invention for the external device to be replaced with another microcontroller, preferably also contained within the housing of FIG. 6, and serving the purpose of storing the text to be displayed and providing the user with a means of selecting the text to be displayed. In this embodiment, the entire device may become self-contained and the present invention may be used as a portable Braille reader and display.

In an advantageous embodiment of this invention, the material from which the Braille discs, housing, and other components are formed is preferably of a light-weight polymer, aluminum, or stainless steel, although other materials may be used if it is advantageous to do so, or if a different material is required depending on the machinery used to form these parts.

The above description is not intended to limit the meaning of the words used in the following claims that define the invention. Persons of ordinary skill in the art will understand that a variety of other designs still falling within the scope of the following claims may be envisioned and used. It is contemplated that future modifications in structure, function, or result will exist that are not substantial changes and that all such insubstantial changes in what is claimed are intended to be covered by the claims.

I claim:

1. A device providing a refreshable Braille display, comprising a plurality of movable actuators, each actuator having protrusions on its outside surfaces that form possible portions of a Braille character, wherein the surfaces of adjacent actuators may be moved and permutated to generate entire characters of readable Braille text.

2. The device providing a refreshable display of claim 1, wherein the movable actuators comprise rotatable discs, and each of the discs has a plurality of faces bearing the protrusions.

3. The device providing a refreshable Braille display of claim 2, wherein the discs comprise wheels in the shape of regular polygons.

4. The device providing a refreshable Braille display of claim 2, wherein the protrusions on a particular face form possible portions of one-half of a Braille character, such that the faces of adjacent discs read together form entire Braille characters, and the discs may be rotated and permutated to allow the reading of multiple lines of Braille text.

5. A device providing a refreshable Braille display, comprising:
a housing having a reading plane;
a plurality of Braille discs rotatable on an axis and mountable within the housing, each disc having a plurality of faces, and each face having protrusions that form portions of Braille characters which display on the reading plane;
whereby when adjacent faces of adjacent discs are read on the reading plane, entire Braille characters may be read by a visually impaired person.

6. The device providing a refreshable Braille display of claim 5, wherein information from a personal computer monitor is transmitted to an electromechanical device controlling movement of the Braille discs.

7. The device providing a refreshable Braille display of claim 5, further comprising one or more electromechanical devices operably attached to the axis and used to rotate the axis and the Braille discs into desired positions.

8. The device providing a refreshable Braille display of claim 7, further comprising a microcontroller programmed to control the operation of the one or more electromechanical devices.

9. The device providing a refreshable Braille display of claim 8, further comprising an electronic device controlling operations of the microcontroller, so that information and data from the electronic device may be transferred from the microcontroller to the one or more electromechanical devices.

10. The refreshable Braille display of claim 8, wherein the electronic device comprises one or more of the following: a personal computer; a mainframe computer; a PDA; an embedded microcontroller; or a wirelessly attached controller.

11. A method of refreshably displaying Braille characters on a reading plane using adjacent actuators, each of the actuators having multiple discrete surfaces bearing protrusions that collectively enumerate all possible combinations for Braille letters, such that adjacent actuators allow the reading of valid Braille characters, comprising the following steps:
rotating a first actuator into a position wherein a discrete surface of the first actuator is visible on the reading plane;
rotating a second actuator adjacent to the first actuator into a position wherein a discrete surface of the second actuator is substantially coplanar with the discrete surface of the first actuator, thereby forming a single Braille character from the combination of the two half-letters formed by the movement of the actuators that is legible on a reading plane; and
continuing the first two steps with these and other actuators to enable a visually impaired person to read multiple lines of Braille on the reading plane.

12. The method of claim 11, wherein each actuator comprises a rotatable disc.

13. The method of claim 11, further comprising the step of using an electronic device to transmit control signals to control movements of the actuators to provide Braille characters in an order which may be read as stored in the memory of the electronic device.

14. The method of claim 13, further comprising the step of using one or more electromechanical devices to move the actuators in response to control signals received from the electronic device.

15. The method of claim 14, wherein the electronic device comprises one or more of the following: a personal computer; a mainframe computer; a PDA; an embedded microcontroller; or a wirelessly attached controller.
